(19) United States
(12) Patent Application Publication
(10) Pub. No.: US 2015/0147175 A1
(43) Pub. Date: May 28, 2015

(54) WIND TURBINE AND METHOD FOR CONTROLLING A WIND TURBINE OR A WIND FARM

(71) Applicant: Wobben Properties GmbH, Aurich (DE)

(72) Inventors: Jurgen Stoltenjohannes, Aurich (DE); Werner Hinrich Bohlen, Emden (DE); William Meli, Wilhelmshaven (DE)

(73) Assignee: Wobben Properties GmbH, Aurich (DE)

(21) Appl. No.: 14/408,194

(22) PCT Filed: Jun. 11, 2013
(86) PCT No.: PCT/EP2013/062030

§ 371 Date: Dec. 15, 2014

(30) Foreign Application Priority Data
Jun. 15, 2012 (DE) 10 2012 210 150.0

(51) Int. Cl. F03D 11/00; F03D 7/04

(52) U.S. Cl. CPC F03D 11/0091; F03D 7/045; F03D 7/048; F03D 11/0025
USPC 416/1; 416/37

(57) ABSTRACT

The invention concerns a wind power installation comprising a pod, a rotor, a first and/or second microwave technology and/or radar technology measuring unit for emitting microwaves and/or radar waves and for detecting the reflections of the microwaves and/or radar waves to acquire wind data and/or meteorological data or information in respect of a wind field in front of and/or behind the wind power installation, and a control means of the wind power installation, which controls operation of the wind power installation in dependence on the data detected by the first and/or second measuring unit.

### BACKGROUND

1. Technical Field

The present invention concerns a wind power installation and a method of controlling or regulating a wind power installation or a wind park.

2. Description of the Related Art

For controlling or regulating a wind power installation, it is advantageous if variables such as for example wind speed or the meteorological characteristic values are known. The better and the more accurately that the measurement of the variables involved in the wind conditions is implemented, the better the wind power installation can be adjusted to those variables.

EP 1 432 911 B1 shows an early warning system for a wind power installation based on a SODAR system mounted to the pod of the wind power installation and detecting the region in front of the rotor of the wind power installation. The wind conditions in front of the wind power installation can be detected by means of the SODAR system and control or regulation of the wind power installations can be appropriately adapted.

JP 2002 152975 A shows a wind power installation and a separately arranged radar unit for detecting a wind vector.

EP 1 770 278 A2 shows a system for controlling a wind power installation. The wind speed in front of the wind power installation is detected by means of a light detection and ranging device LIDAR, by detection of the reflection or scatter of the transmitted light, and the wind power installation is correspondingly controlled.

U.S. Pat. No. 6,166,661 discloses an ice detection system for an aircraft having a radar system.

US 2002/0067274 A1 discloses a method of detecting a hail storm with a radar unit, wherein the radar unit is used to detect and track the hail storm. When a hail storm is detected a warning signal is produced and the position of the rotor blades can be appropriately altered.

### BRIEF SUMMARY

One or more embodiments of the present invention are to provide a wind power installation and a method of controlling or regulating a wind power installation or a wind park that permits improved adaptation to wind conditions or meteorological characteristic values in the area surrounding the wind power installation.

Thus there is provided a wind power installation comprising a pod, a rotor, a spinner, a first and/or second microwave technology and/or radar technology measuring unit for emitting microwaves and/or radar waves and for detecting the reflections of the microwaves and/or radar waves to acquire wind data and/or meteorological data or information in respect of a wind field in front of and/or behind the wind power installation. The wind power installation also has a regulator which controls operation of the wind power installation in dependence on the data detected by the first and/or second measuring unit. The first and/or second microwave technology and/or radar technology measuring unit is arranged on the pod and/or on the spinner.

One or more embodiments are based on the notion of providing on the pod of the wind power installation or in the region of the spinner (the rotating part of the wind power installation) a measuring unit which detects the wind conditions or meteorological conditions in front of and/or behind the wind power installation by means of microwave technology or radar technology. The wind data and/or meteorological data detected by the measuring unit can be passed to a control means of the wind power installation. The control means of the wind power installation can be based on a feed forward principle so that operation of the wind power installation can be adapted based on the wind data detected by the measuring unit, for example to maximize the yield or to minimize the loading on the wind power installation.

Turbulence, an inclined afflux flow, a trailing wake flow, a wind shear, a wind veer, a wind direction and/or a wind speed can be determined by means of the microwave technology or radar technology measuring unit.

According to one embodiment, the wind data detected by the measuring unit can be used for monitoring the status of the wind power installation and the models of the wind power installation can be correspondingly adapted.

In accordance with one embodiment, the wind data detected by the measuring unit can be used for controlling wind power installations in a wind park.

In a further aspect the wind data can be used for monitoring the structure of the rotor blades.

The meteorological characteristic values can be for example wind speed (for example with its horizontal component), derived parameters like wind speed profile (wind shear), turbulence phenomena, standard deviations/mean wind speed, inclined afflux flow (wind speed with a vertical component), wind direction, wind rotation profile over the circular rotor area (wind veer), air pressure, air temperature, air humidity, air density, kind of precipitation, clouding, visibility and/or global radiation.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind power installation according to one embodiment,

FIG. 2 shows a diagrammatic view of a wind power installation according to one embodiment,

FIG. 3 shows a diagrammatic view of a feed forward control means of a wind power installation according to one embodiment,

FIG. 4 shows a diagrammatic view of status monitoring in a wind power installation according to one embodiment,

FIG. 5 shows a diagrammatic view of optimization of a model of a wind power installation according to one embodiment,

FIG. 6 shows a schematic block circuit diagram of a wind park according to one embodiment,

FIG. 7 shows a schematic view of a central wind park regulation system according to one embodiment,

FIG. 8 shows a diagrammatic view of a wind power installation according to one embodiment,

FIG. 9 shows a diagrammatic view of a wind power installation according to one embodiment,

FIG. 10 shows a diagrammatic view of a wind power installation according to one embodiment,

FIG. 11 shows a further diagrammatic view of a wind power installation according to one embodiment,

FIG. 12 shows a further diagrammatic view of a wind power installation according to the invention, and

FIG. 13 shows a diagrammatic view of a plurality of measurement fields for a wind power installation according to one embodiment.

### DETAILED DESCRIPTION

A prediction of the wind structure represents a possible way of reducing the aerodynamic loading on the wind power installation and in particular the rotor thereof caused by the wind. In that respect for example the angle of incidence (pitch angle) of the rotor blades can be suitably varied. By means of prediction of the wind structure for example by the microwave technology or radar technology measuring unit, it is also possible to implement yield optimization, sound optimization, structure monitoring and the like, both for a wind power installation and also for a wind park for a plurality of wind power installations.

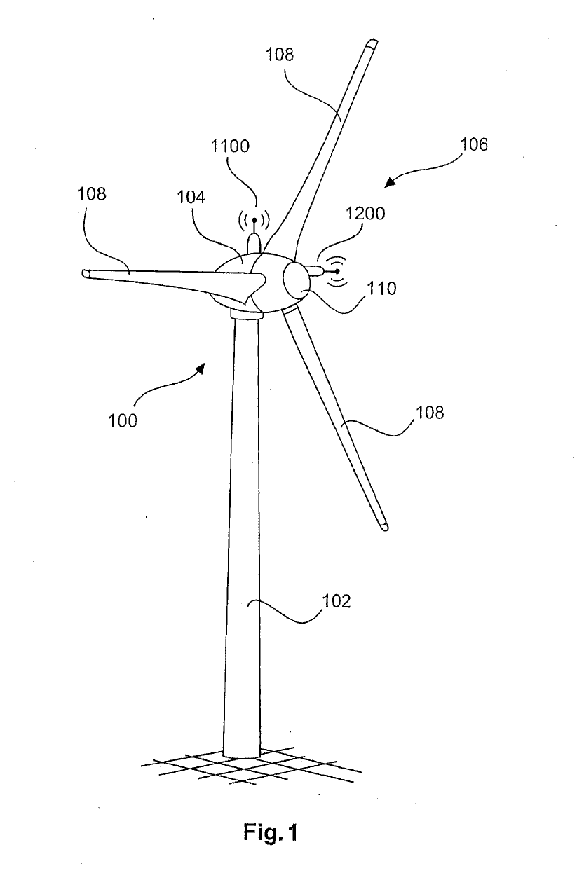

FIG. 1 shows a diagrammatic view of a wind power installation 100 according to an embodiment. FIG. 1 shows a wind power installation 100 having a pylon 102 and a pod 104. Arranged on the pod 104 is a rotor 106 with three rotor blades 108 and a spinner 110. In operation the rotor 106 is caused to rotate by the wind and thereby drives a generator in the pod 104. The angle of incidence (pitch angle) of the rotor blades 108 is adjustable. A microwave or radar technology measuring unit 1100 can be provided on the pod and/or a further microwave and/or radar technology measuring unit 1200 can also be provided on the spinner 110. Those measuring units 1100, 1200 serve to detect the wind conditions in front of the wind power installation 100 (in the case of the measuring unit 1200) or in front of and behind the wind power installation 100 (in the case of the measuring unit 1100).

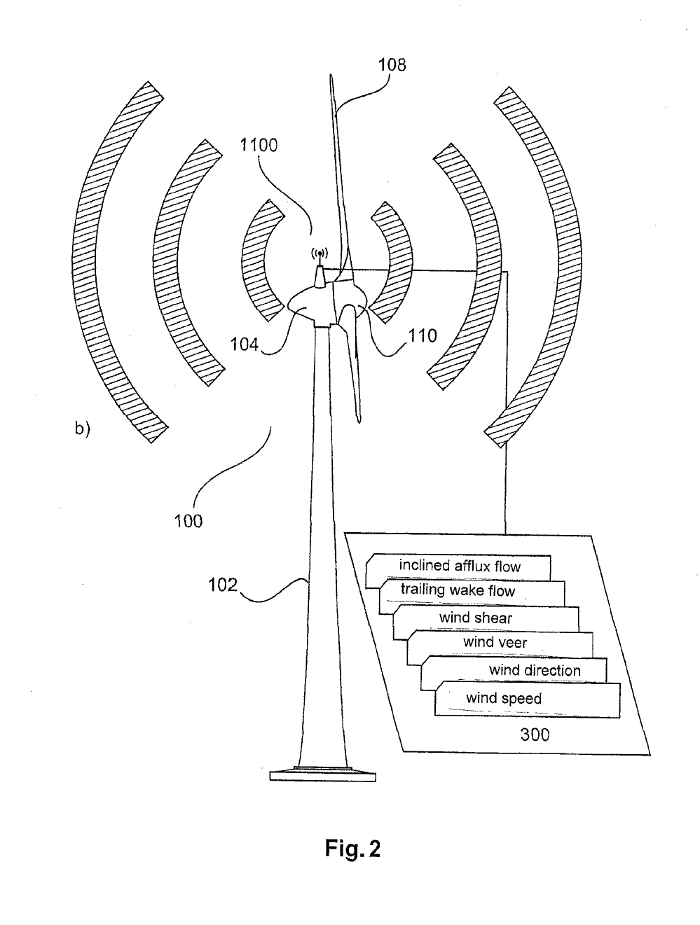

FIG. 2 shows a diagrammatic view of a wind power installation according to one embodiment. The wind power installation of FIG. 2 can correspond to the wind power installation of the embodiment of FIG. 1. A microwave or radar technology measuring unit 1100 is provided on the pod 104 of the wind power installation. The measuring unit 1100 can emit radar waves and/or microwaves and can detect reflections of those radar waves or microwaves in order to derive therefrom information about the wind conditions and/or meteorological conditions in front of and behind the wind power installation. In particular arranging the measuring unit 1100 on the pod 104 (that is to say the part of the installation, that does not rotate), makes it possible to detect the wind conditions both in front of and also behind the wind power installation 100. The wind conditions behind the wind power installation 100 can also be of significance as they can give information inter alia about the effectiveness in conversion of kinetic energy into a rotary movement of the rotor blades 108.

If the microwave or radar technology measuring unit 1200 is provided on the spinner 110 of the wind power installation 100, then the wind conditions in front of the wind power installation can be detected. In accordance with the embodiment of FIG. 2, turbulence phenomena, an inclined afflux flow, a trailing wake flow, a wind shear, a wind veer, a wind direction and a wind speed can be detected by means of the measuring units 1100, 1200 and a regulator 300. In that respect the wind veer represents the rotation in wind direction in respect of height and wind shear represents the wind profile in respect of height. Those measurement variables can be detected by means of the measuring unit 1100, 1200 and passed to the control means of the wind power installation, which can suitably adapt the control laws of the wind power installation.

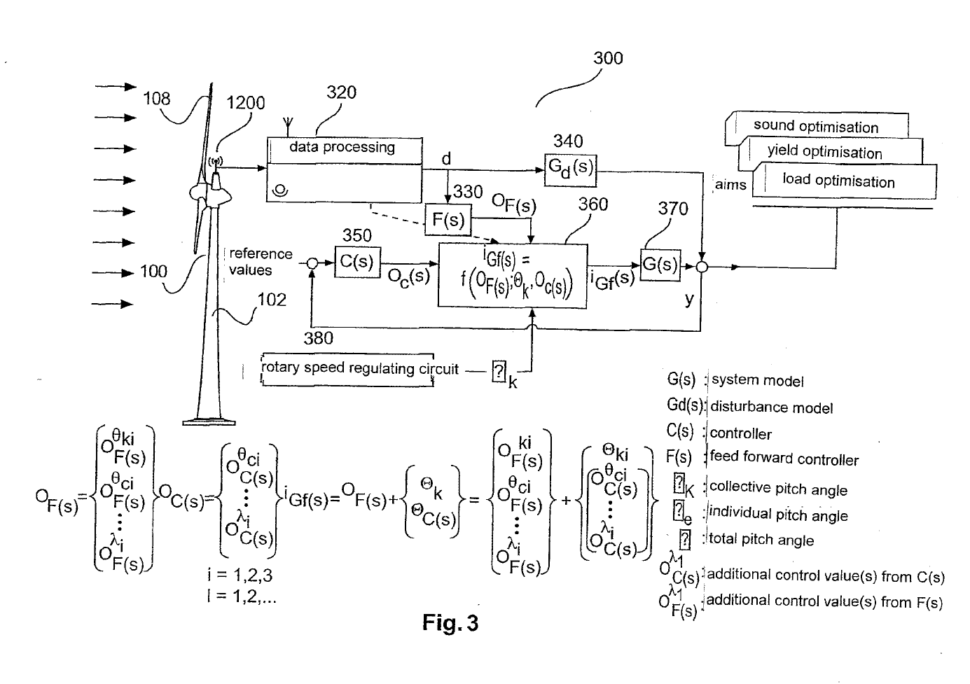

FIG. 3 shows a diagrammatic view of a feed forward regulator 300 of a wind power installation according to an embodiment. The wind power installation 100 of the embodiment of FIG. 3 can be based on a wind power installation 100 according to the embodiments of FIGS. 1 and 2. In particular FIG. 3 shows a regulator 300 of the wind power installation. The wind power installation 100 of FIG. 3 also has a microwave technology or radar technology measuring unit 1100 or 1200. The data acquired by the measuring unit 1100, 1200 can be processed in a data processing unit 320 of the regulator 300. The regulator 300 of the wind power installation 100 can have a feed forward regulator 330, a system model unit 370, a disturbance model unit 340, a controller 350 and a rotary speed regulating circuit 380.

From the wind field data or wind data detected by the measuring unit 1200 and/or meteorological data, it is possible to determine those parameters which are characteristic of disturbance effects in the wind field. If the disturbances are previously known then it is possible to counteract the disturbance effects by means of a feed forward control. The measuring unit 1200, as already described above, can ascertain wind speed, wind direction, wind veer, wind shear, trailing wake flow, turbulence and/or an inclined afflux flow. A disturbance behavior is stored in the disturbance model unit 340 and a model of the wind power installation is stored in the system model unit 370.

The direction of the control value i_{Gf} (s) can be ascertained on the basis of the measurement data of the measuring unit 1200. That can be effected in the feed forward regulator 330. Imaging of the disturbance values on to the process output can be modelled in the disturbance model unit 340. Disturbance value compensation can be implemented by means of the disturbance model unit 340. Compensation in respect of the disturbance values can be effected by way of the pitch angle of the rotor blades by the feed forward regulation (forward regulation). Alternatively to or additionally to adjustment of the setting angle it is also possible to perform a change in profile of the rotor blades (that is to say an active change to the rotor blade for pitch adjustment). The regulator 350 serves to adapt the regulator law for mapping of the optimization aims to on the control options. The modification laws for the pitch angle and the other control values can be provided in the regulator 350.

The wind structure at the location of the wind power installation and the meteorological characteristics thereat can be used for improving the disturbance transmission function.

Optionally, adaptation of the transmission function F(s) can be effected to optimize the feed forward regulator 330. In other words, the parameters of the transmission function F(s) can be adapted on the basis of the measurement data of the measuring unit 1200 or 1100, that are processed in the data processing unit 320. That can make it possible to provide for adaptive compensation of the disturbance value.

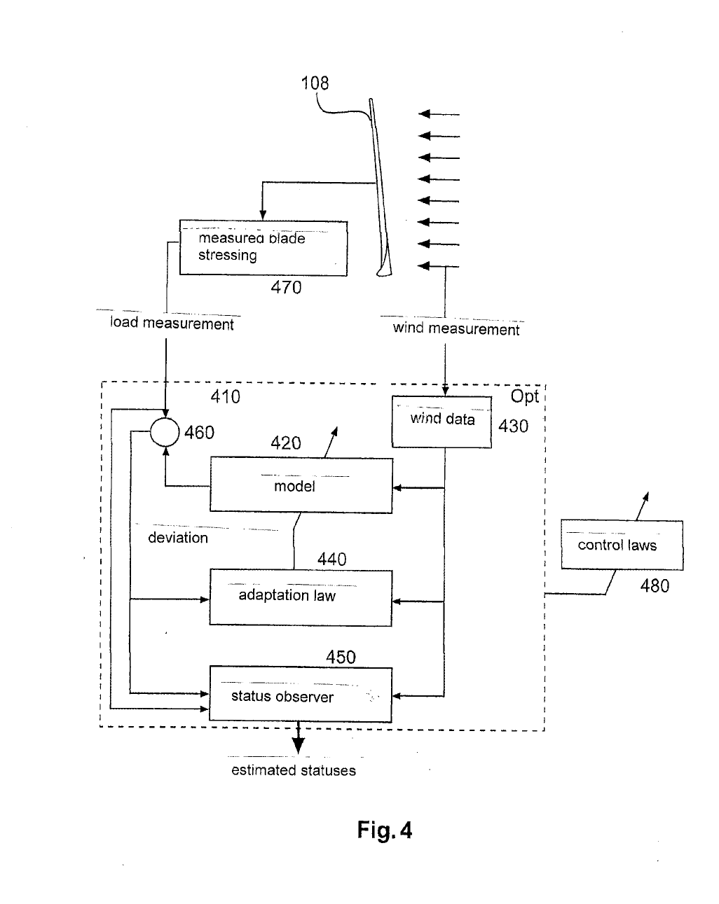

FIG. 4 shows a diagrammatic view of status monitoring of a wind power installation according to one embodiment. The measurement data of the measuring units 1100, 1200 can be used for a status monitoring unit 410 of the wind power installation or parts thereof. The status monitoring unit 410 of the wind power installations is utilized to reduce inter alia installation stoppage times. In addition status monitoring can be used for further development of the wind power installations. Status monitoring can be used both for the rotor blades, the pod, the rotor and/or the pylon of the wind power installations.

The measurement data of the measuring unit 1100, 1200 can be stored in a wind data storage unit 430. The actual stresses on the rotor blades 108 can be detected by means of a blade stress measuring unit 470. The wind data stored in the wind data storage unit 430 are fed to the wind power installation model unit 420 which inserts the data into the model. The output signals of the model unit 420 are compared to the output signals of the blade stress measuring unit 470 in a comparison unit 460. If no deviation can be detected, the model then corresponds to the actual wind power installation. If however there are deviations then that indicates that the model stored in the model unit 420 is not in conformity with reality. In a status observation unit 450, the wind data detected by the measuring unit 1100, 1200 can be used for model status estimation. A current structure status of that rotor blade 108 can be reconstructed on the basis of the estimated statuses.

If, in the comparison between the detected blade stressing and the blade stressing ascertained by the model, it is found that there are differences, the theoretical load model assumptions relating to the wind park position can be adapted. That can be effected in the adaptation law unit 440. Adaptation can be effected both online and also offline.

When the wind power installation is brought into operation the load assumption can be checked by means of the measurement results of the measuring unit 1100, 1200. If the deviations between the ascertained measurement values and the values determined by the model are excessively great, changes for load optimization can be effected in the control law unit 480. That can be advantageous in regard to costs, sound optimization and yield optimization.

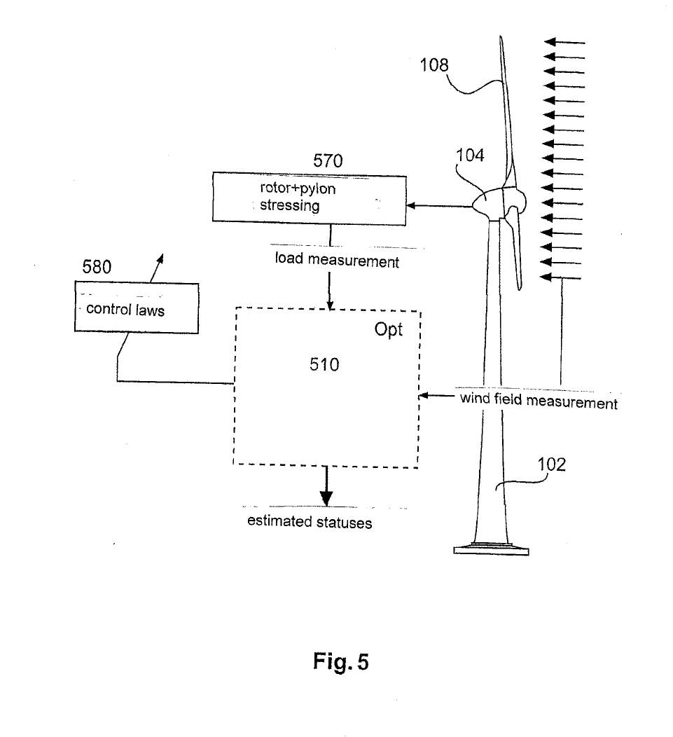

FIG. 5 shows a diagrammatic view of optimization of a model of a wind power installation according to one embodiment. In FIG. 5, apart from monitoring of the loading on the rotor blades 108, a monitoring unit 510 can also be provided for monitoring the loading on the rotor 106 and the pylon 102. For that purpose there is provided a rotor and/or pylon stress monitoring unit 570, an optimization unit 520 and optionally a control law unit 580. Optimization in terms of load technology can be effected in that respect as described with reference to FIG. 4.

Load and/or yield optimization or sound optimization can also be effected not just for a single wind power installation but also for a wind park comprising a plurality of wind power installations. In that case, both the local wind situation and also the wind park topology (number of wind power installations, orientation of the wind power installations, spacing between the wind power installations) can be taken into account.

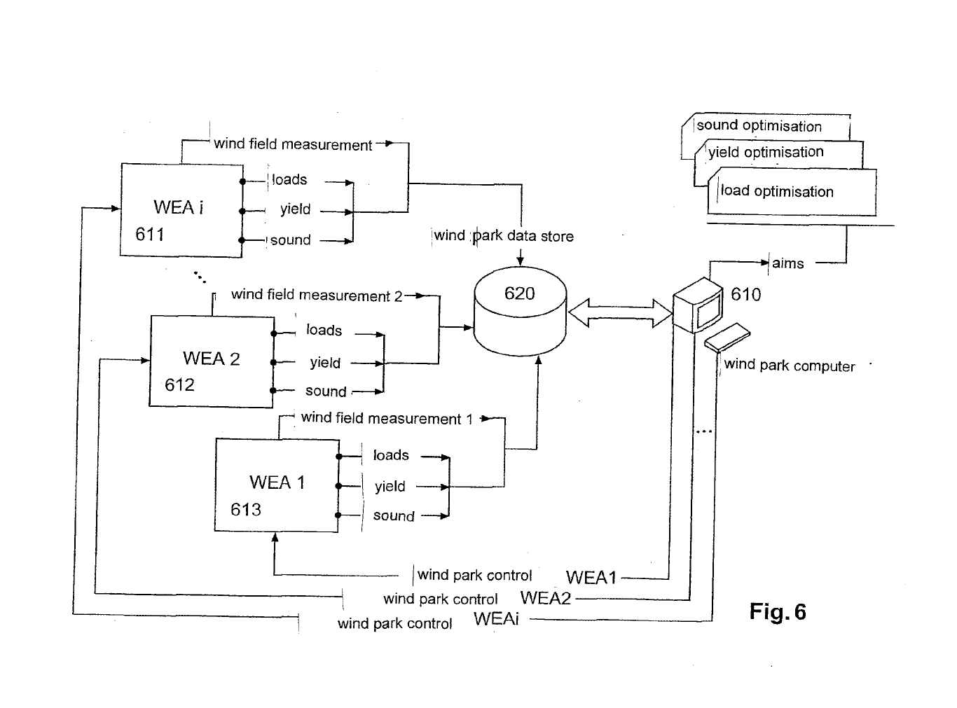

FIG. 6 shows a schematic block circuit diagram of a wind park according to one embodiment. In the FIG. 6 situation, a wind park can have a plurality of wind power installations 611, 612, 613, wherein at least one of the wind power installations has a microwave technology or radar technology measuring unit 1100, 1200. The results of wind measurement can be passed to a central wind park data store 620.

A wind park computer 610 can be connected to the wind park data store 620. The wind park computer 610 can also be respectively connected to the wind power installations and can control same. Control of the individual wind power installations of the wind park can be based on sound optimization, yield optimization and/or load optimization.

A feed forward regulator according to the embodiment of FIG. 3 can be provided in the respective wind power installations of the embodiment of

FIG. 6. Additionally or alternatively thereto, for example feed forward compensation according to the embodiment of FIG. 3 can also be implemented in the wind park computer 610. At least the wind data of a measuring unit 1100, 1200 on a wind power installation serve as input signals for feed forward compensation. Preferably however the wind data of the measuring units 1100, 1200 of all wind power installations are also taken into consideration. The wind park computer 610 can also be adapted to control the wind power installations 100 in such a way that the loading is uniformly distributed to the wind power installations 100.

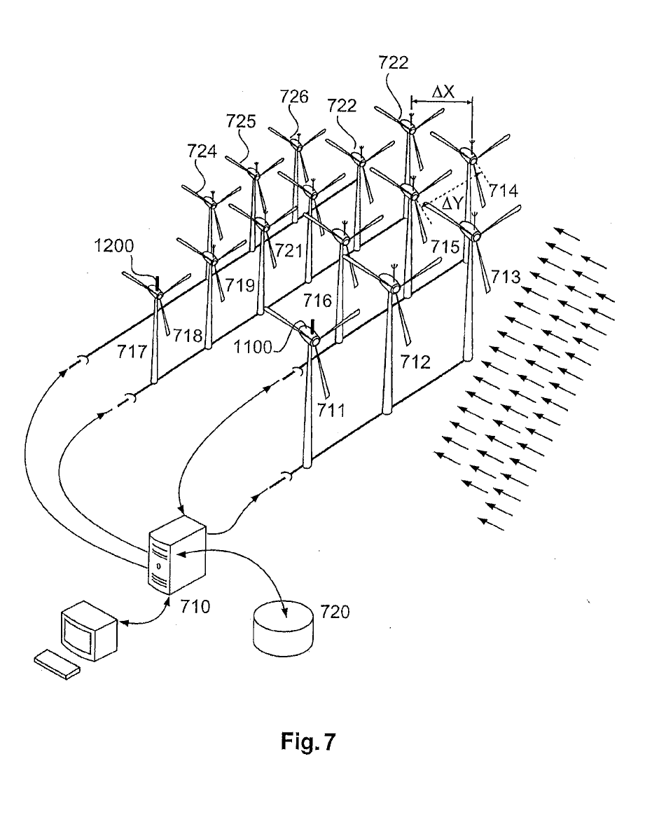

FIG. 7 shows a diagrammatic view of a central wind park regulating system according to one embodiment. FIG. 7 shows a plurality of wind power installations 711-726, which may be any one of the wind power installations described herein, connected to a central wind park computer 710. The wind park computer 710 is in turn coupled to a wind park data store 720. The distance in relation to adjacent wind power installations is Ax and Ay respectively.

FIG. 8 shows a diagrammatic view of a wind power installation according to one embodiment. FIG. 8 shows a wind power installation 100 comprising a pylon 102, a pod 104 and a first and/or second microwave or radar measuring unit 1100, 1200. The first and/or second measuring unit can be used to measure the rotor blades 108. Taking the measurement data of the first and/or second measuring unit 1100, 1200, a rotor blade flexural line, surface erosion, a blade angle, blade statuses, blade torsion and ice detection can be ascertained in a rotor blade measuring unit 810.

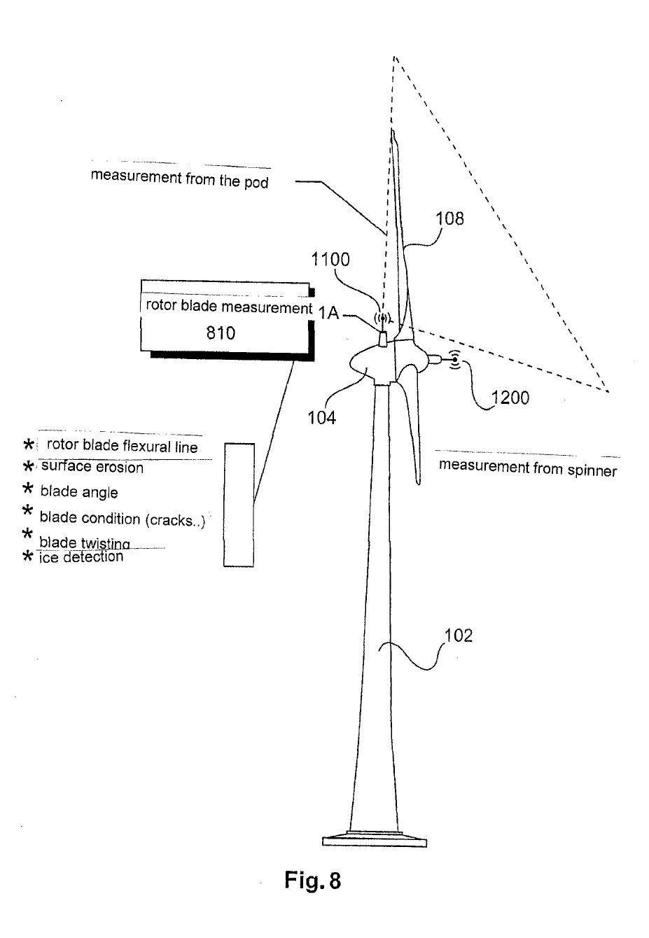

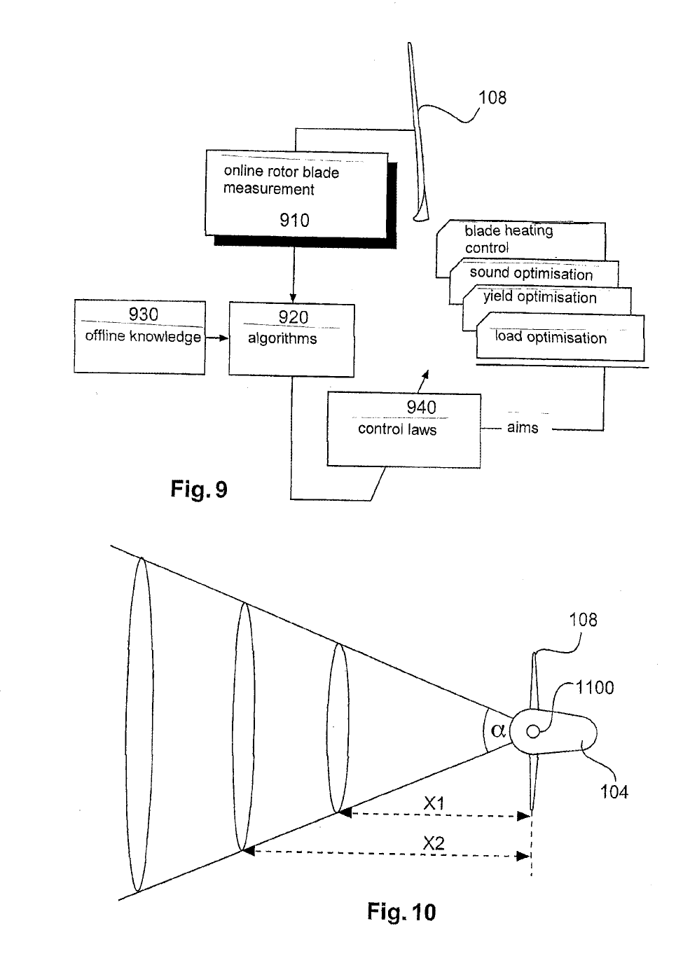

FIG. 9 shows a diagrammatic view of a wind power installation according to one embodiment. The rotor blades 108 of a wind power installation are measured by means of a rotor blade measuring unit 910. The results of the rotor blade measuring unit 910 are passed to an algorithm unit 920. In addition data from an offline knowledge unit 930 are also fed to the algorithm unit 920. The output signal of the algorithm unit 930 can be passed to a control law unit 940.

The turbulence generated by one of the wind power installations can be reduced in a wind park so that the spacing relative to the adjacent wind power installations can be reduced.

In respect of detection of the after-field, the wind power installation 100 can be operated in such a way that the power of an adjacent or following wind power installation is optimized or the overall power of the wind power installations of the wind park is optimized.

In a further aspect, the blade measurement can be effected with the above-described wind power installation 100 and the microwave technology and/or radar technology measuring unit 1100, 1200, insofar as the rotor blades are measured by means of the measuring unit.

In a further aspect, not only the rotor blades but also other parts of the wind power installation can be detected and measured by means of the microwave technology and/or radar technology measuring unit so that the wind power installation, at any time, is aware of a currently prevailing status of the installation. Erosion (deviation from the reference or target status) and/or ice accretion on the rotor blade can be detected by means of the microwave technology and/or radar technology measuring unit. Not only erosion or ice accretion but also the position of erosion and ice accretion can be determined with the microwave technology and/or radar technology measuring unit.

FIG. 10 shows a diagrammatic view of a wind power installation according to one embodiment of the invention. This shows a pod 104 and two rotor blades 108 of the wind power installation 100. In addition a measuring unit 1100 is provided on the pod and irradiates a measurement field with a spread angle α. The area of the measurement plane is increased in dependence on the distance x1, x2, from the measuring unit 1100.

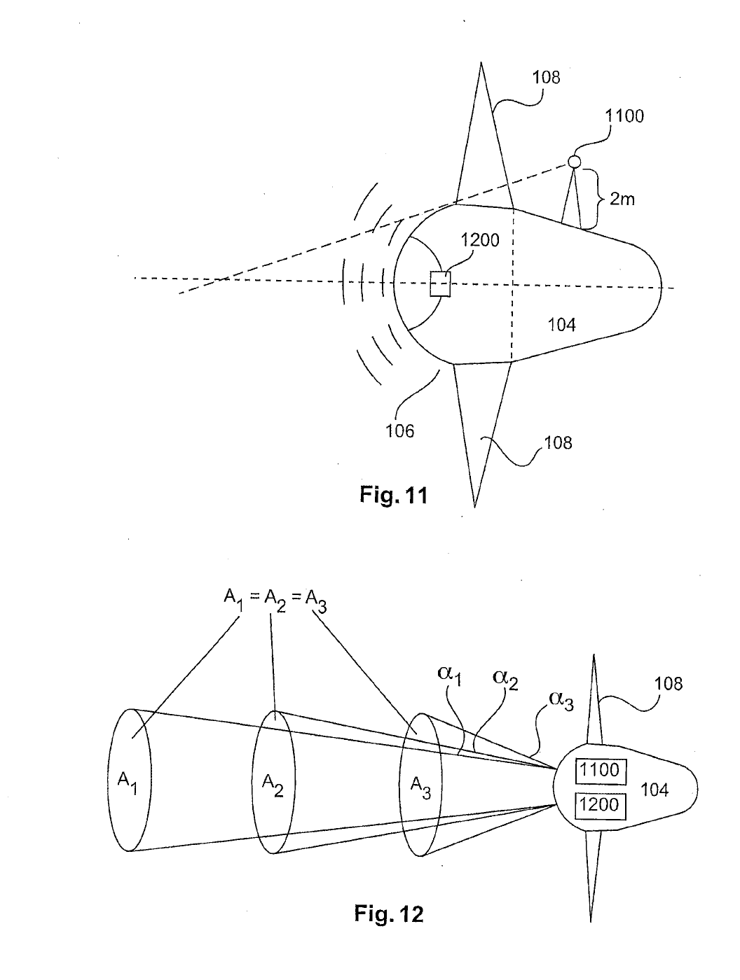

FIG. 11 shows a further diagrammatic view of a wind power installation according to one embodiment of the invention. A measuring unit 1100 can be arranged on the pod 104 for example at a height of 2 m (or higher). The measuring unit 1100 may be at a minimum height above the pod 104 so that it can measure a wind field in front of the wind power installation.

Optionally a further measuring unit 1200 can be provided on the rotor 106 of the wind power installation. In that respect the geometry of the rotor 106 can be used for mounting the measuring unit. If a measuring unit 1200 is arranged on the rotor 106, shadowing because of the rotor blade movement (as in the case of a measuring unit 1100 according to the invention) can be avoided.

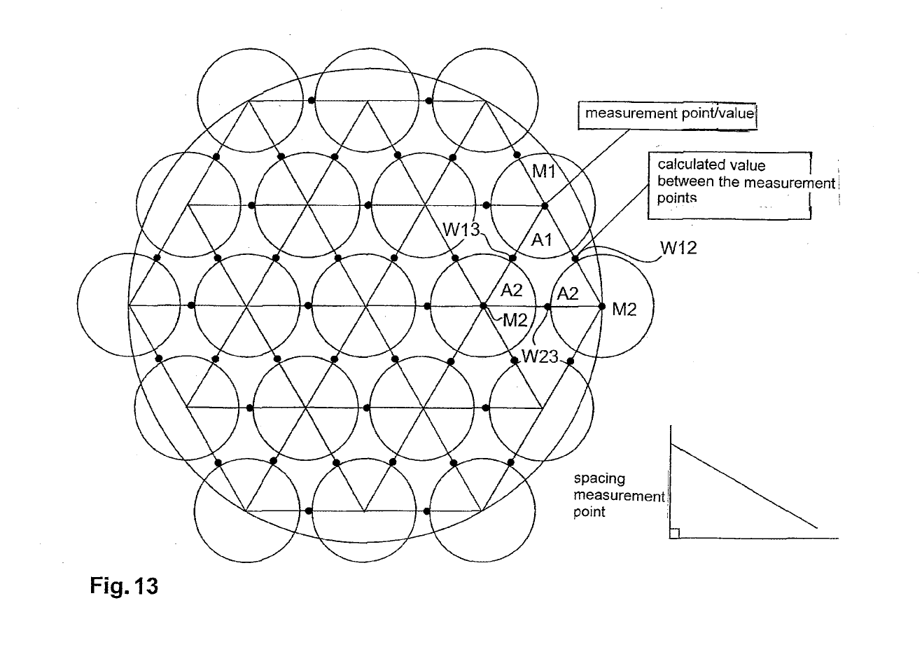

FIG. 12 shows a further diagrammatic view of a wind power installation according to one embodiment of the invention. The installation can have measuring unit 1100 and/or 1200. By virtue of the selection of the respective spread of the respective spread angle α1, α2 and α3—as shown—it is possible to ensure that the measurement planes A1, A2, A3 are of the same size or the same area.

FIG. 13 shows a diagrammatic view of a plurality of measurement fields for a wind power installation according to one embodiment of the invention. The use of a plurality of measurement fields A1, A2, A3 makes it possible to ascertain both a measurement value within the respective measurement fields A1, A2, A3 and also measurement values between the respective measurement points. It is thus possible to provide for more accurate detection of the wind fields in front of and behind the wind power installation. There are at least two measurement points M1, M2 calculating the wind vector W12 by means of the spread angle α. The wind speed along the measurement path can be detected with only one measurement point. The spacing of the measurement points in the direction of the blade tip is reduced, that is to say a higher level of resolution is made possible in the outer blade region. In that respect it is pointed out that it is precisely in the blade outer region, due to the spacing relative to the rotor axis, that blade flexing moments are generated, which can now be detected.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation, comprising:
a pod;
a rotor arranged on the pod, the rotor being configured to rotate relative to the pod;
a spinner on the rotor;
a measuring unit arranged on at least one of the pod and the spinner, the measuring unit configured to emit at least one of microwaves and radar waves and detect reflections of the emitted microwaves and radar waves to acquire at least one of wind data, meteorological data and information with respect to a wind field proximate the wind power installation; and
a regulator configured to control an operation of the wind power installation in dependence on the acquired data and information detected by the measuring unit.

2. The wind power installation according to claim 1 wherein the regulator is based on a feed forward regulation and the wind data acquired by the measuring unit is used for feed forward regulation.

3. The wind power installation according to claim 1 wherein the measuring unit is adapted to ascertain at least one of an inclined afflux flow, a trailing wake flow, a wind shear, a wind veer, a wind direction and a wind speed proximate the wind power installation.

4. The wind power installation according to claim 1 wherein the regulator has a model unit, wherein the wind data acquired by the measuring unit is provided to the model unit and results of modelling in the model unit are compared to actually ascertained parameters of the wind power installation.

5. A method of controlling one or more wind power, wherein wind power installations has a pod, a spinner a rotor, the method comprising;
emitting at least one of microwaves and radar waves from measuring units located on the wind power installation;
receiving at least one of reflected microwaves and radar waves by the measuring unit;
determining information about the wind data proximate the wind power installation based on the at least one of received reflected microwaves and radar waves; and
controlling at least one wind power installation based on the determined wind data.

6. A wind park comprising:
a plurality of wind power installations, wherein the plurality of wind power installations are wind power installations according to claim 1, wherein the measuring unit of one of the wind power installations includes a first and second microwave technology and radar technology measuring units that are adapted to measure the wind field behind the wind power installation,
wherein the regulator of the wind power installation is adapted to optimize operation of the wind power installation and to intervene in operation of the wind power installation to optimize an amount power produced by the wind park with the plurality of wind power installations in dependence on the wind field.

7. The wind power installation according to claim 1, further comprising at least two rotor blades) coupled to the rotor,
wherein the measuring unit includes first and second microwave technology and radar technology measuring units that are adapted to measure the rotor blade using the microwaves and radar waves.

8. The wind power installation according to claim 7 wherein at least one of the first and second microwave technology and radar technology measuring unit is adapted to detect at one of an erosion and ice accretion on the rotor blades.

9. The wind power installation according to claim 1, wherein the measuring device includes a first measuring device for emitting microwaves and second measuring device for emitting radar waves.

10. The wind power installation according to claim 1, wherein the measuring unit is configured to emit both microwaves and radar waves and detect reflections of the emitted microwaves and radar waves to acquire at least one of wind data, meteorological data and information with respect to a wind field proximate the wind power installation.
